(19) United States
(12) Patent Application Publication
(10) Pub. No.: US 2015/0036326 A1
(43) Pub. Date: Feb. 5, 2015

(54) MODULAR SHELF ILLUMINATION SYSTEM FOR GONDOLA DISPLAY

(71) Applicant: Peter Scott Maciulewicz, Auburn, NY (US)

(72) Inventor: Peter Scott Maciulewicz, Auburn, NY (US)

(21) Appl. No.: 13/954,335

(22) Filed: Jul. 30, 2013

(51) Int. Cl. A47F 5/00; G09F 13/00

(52) U.S. Cl. CPC A47F 5/0018; G09F 13/00
USPC 362/133; 29/825

(57) ABSTRACT

A modular illumination system for a gondola display having a power panel that attached over a gondola and includes electrically powered standards for supplying power to a shelf connected to the panel. Shelves having electrically conductive brackets are adapted to interconnect to and be suspended from various corresponding locations along standards. Illumination sources, such as LED strips, are positioned on the shelf and connected to each of the shelf brackets. Each shelf may additionally include one or more auxiliary power outlets attached to the bracket.

### BACKGROUND OF THE INVENTION

1. Field of the Invention

The present invention relates to shelving illumination and, more particularly, to a modular system illuminating one or more shelves.

2. Description of the Related Art

A gondola is a freestanding fixture used to display merchandise and typically comprises flat base and an upstanding vertical wall featuring notches, pegboards, or slats to which shelves, hooks, or other displays can be attached. Gondolas are not typically manufactured to include illumination, so wares displayed on gondola shelves must be illuminated with separate systems. While there are numerous approaches to illuminating shelves and the items placed thereon, these systems require sophisticated lighting equipment and supporting structure and cannot be used in combination with a conventional gondola display.

For example, such systems require power strips that are co-located with the gondola rack and the use of special auxiliary connectors that must be manually connected to the power strips after a shelf has been positioned in the desired location. As a result, each time a shelf is re-configured or moved to a new location, a user must disconnect the shelf plug from the power supply, move the shelf, and then reconnect the power supply to a plug that is located proximately to the new shelf location. These systems also fail to provide auxiliary power outlets to power secondary illumination sources.

### BRIEF SUMMARY OF THE INVENTION

The present invention comprises a modular system for retrofitting a conventional gondola display to include illuminated shelving and auxiliary power. The system includes a power panel having connectors positioned on one side for attaching to a gondola. The opposing side of the power panel includes two vertically extending channels that house electrically conductive standards. Each standard further includes a series of slots formed thereon for receiving and retaining a corresponding shelf bracket. The standards are electrically interconnected to a power supply, such as an AC to DC power supply that can connect to conventional building power and act as a DC voltage source, so that one of the two channel members is positively charged and the other bracket is negatively charged or grounded.

The system further includes at least one illuminated shelf having a horizontal, non-conductive panel for displaying merchandise that extends between first and second electrically conductive brackets that are adapted to interconnect to and be suspended from various corresponding locations along the standards within the two vertically extending channels. Illumination sources, such as LED strips, may be positioned on the shelf, such as underneath the forward edge of the non-conductive panel, and connected to each of the shelf brackets to receive power therefrom. Each shelf may additionally include one or more auxiliary power outlets attached to the bracket so that additional illumination sources may be attached thereto to receive power.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a perspective view of a conventional gondola display system;

FIG. 2 is an exploded perspective view of a modular illumination system for attaching to and retrofitting a gondola according to the present invention;

FIG. 3 is an exploded perspective view of a power panel for a modular illumination system according to the present invention;

FIG. 4 is a perspective view of a modular illumination system for attaching to and retrofitting a gondola according to the present invention;

FIG. 5 is a side elevation view of a shelf for use with a modular illumination system according to the present invention;

FIG. 6 is a top plan view of a shelf for use with a modular illumination system according to the present invention;

FIG. 7 is a perspective view of a shelf for use with a modular illumination system according to the present invention; and

FIG. 8 is a perspective view of a light cube for use with a modular illumination system according to the present invention.

### DETAILED DESCRIPTION OF THE INVENTION

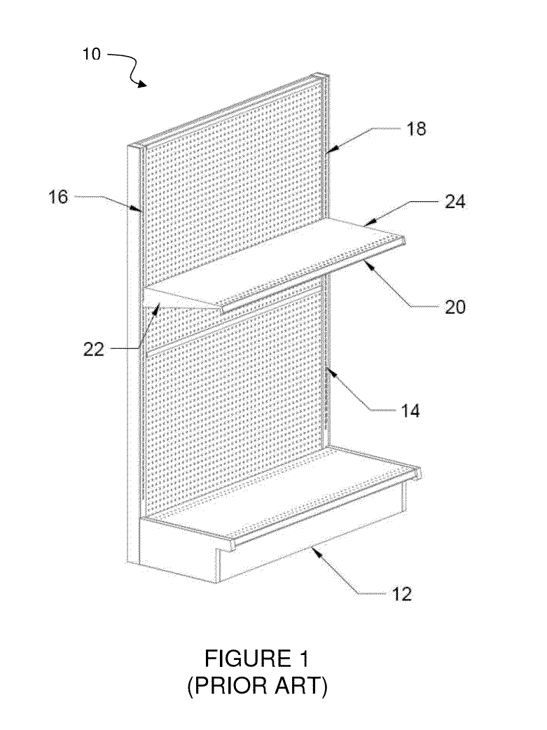

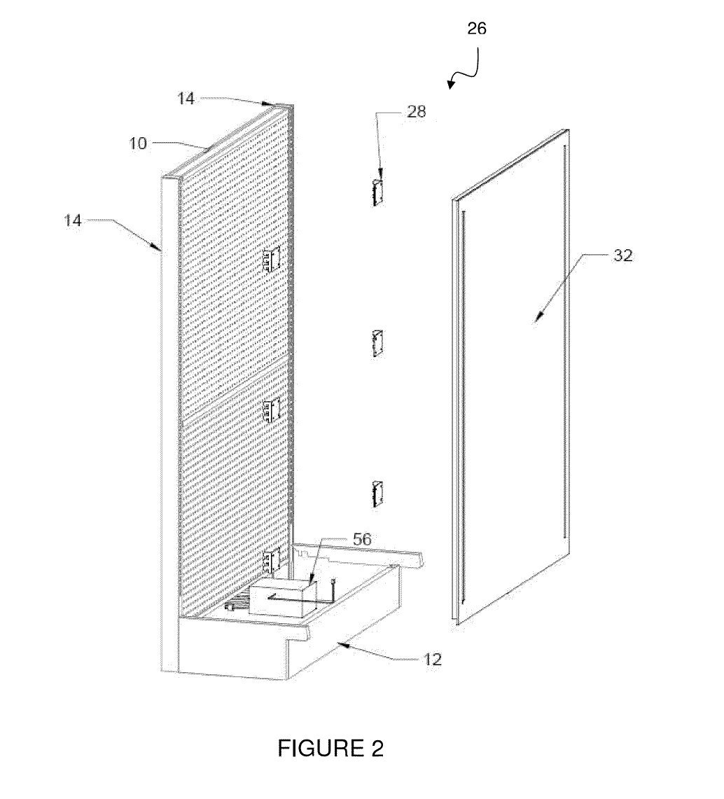

Referring now to the drawings, wherein like reference numerals refer to like parts throughout, there is seen in FIG. 1 a conventional gondola display 10 comprising a load-bearing base 12, one of more vertical uprights 14 extending from base 12 and a pair of standards 16 and 18 positioned on uprights 14 for attaching to and supporting one or more cantilevered shelves 20 via opposing shelf brackets 22 and 24 positioned at the ends of each shelf 20. Referring to FIG. 2, the present invention comprises a modular illumination system 26 for attaching to and retrofitting a gondola 10 to simultaneously supply power to and support illuminated shelves and other light sources.

Referring to FIG. 2, system 26 comprises a power panel 32 having connectors 28 for interconnecting to its rear major surface and for attaching to the pre-existing rack standards 16 and 18 of a gondola 10 so that panel 32 is positioned covering relation to upright 14 of gondola 10. It should be recognized by those of skill in the art that connectors 28 may be positioned in various locations so that panel 32 is securely held to gondola 10. In addition, the particular design of connecters 28 may be varied depending on the particular style of gondola 10. For example, gondola 10 may have conventional rack standards or may include a grid of holes. Thus, connectors 28 may comprise tabs or pins accordingly. Preferably, six connectors 28 are used to position panel 32 on gondola 10.

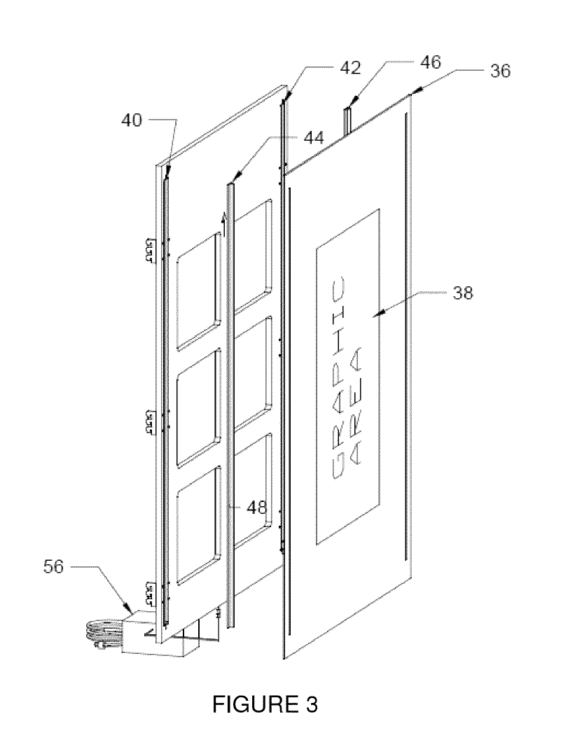

Referring to FIG. 3, the front major surface 36 of panel 32 is thus exposed to viewers of gondola 10 and may be decorated, such as by attaching or adhering an artwork cover 38 thereon. For example, artwork 38 may comprise a sheet of plastic that has been imprinted or colored to enhance the aesthetic appeal of system 26 or to coordinate with the particular color scheme or trade dress of merchandise or items to be positioned and displayed by system 10. Similarly, base 12 of gondola 10 may be covered by corresponding or matching artwork cover 40 that is positioned in covering relation to base 12.

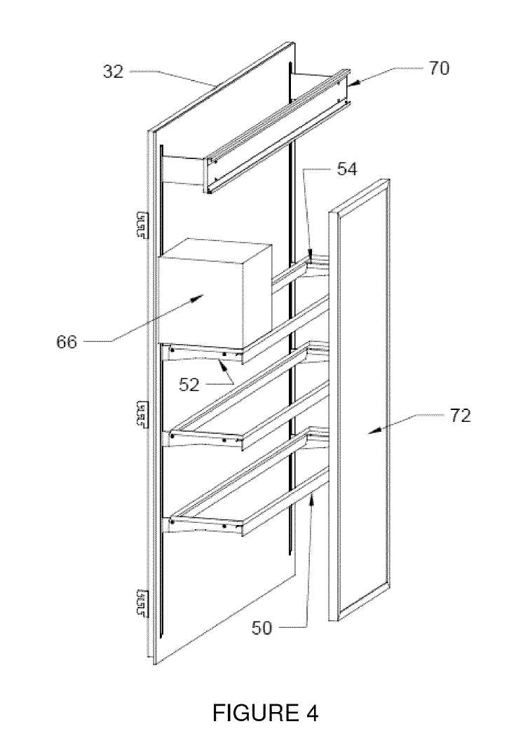

Front major surface 36 of panel 32 includes two vertically extending channels 40 and 42 formed therein that permit access to a pair of spaced apart, electrically conductive standards 44 and 46. Standards 44 and 46 have a series of vertically extending slots 48 formed therein. As further seen in FIG. 4, standards 44 and 46 releasably receive and retain one or more corresponding shelves 50 via a pair of opposing shelf brackets 52 and 54 that are positioned at either end of each shelf 50. Opposing shelf brackets 52 and 54 are adapted to engage with and be retained by slots 52 so that shelf 50 is retained in a horizontal position against panel 32. Brackets 52 and 54 and slots 52 may be configured in various known manners so that shelf 50 is stably retained is a desired location and orientation. Shelf brackets 52 and 54 are electrically conductive while shelf 50 is formed from a non-conductive material, such as wood, acrylic, glass, powder-coated metal, or laminate, etc. to act as an electrical insulator relative to shelf brackets 52 and 54.

As seen in FIG. 3, standards 44 and 46 are electrically interconnected to the opposing terminals of a power supply 56 that may be housed within base 12 of gondola 10, as shown in FIG. 2. For example, power supply 56 may comprise a conventional AC to DC converter that may be interconnected to conventional building power to provide a voltage potential across standards 44 and 46 so that one of the two standards are positively charged while the other standard is negatively charged or grounded. Preferably, power supply 56 supplies a voltage of 12 volts, but other voltages may be used depending on the particular requirements for system 26. Thus, when shelf 50 is engaged with standards 44 and 46 via shelf brackets 52 and 54, shelf brackets 52 and 54 are similarly energized, and when shelf 50 is removed, power is disconnected and shelf brackets 52 and 54 are de-energized.

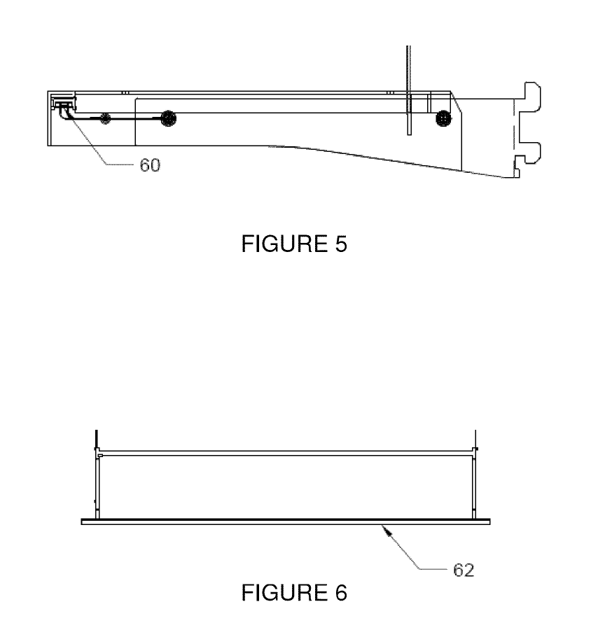

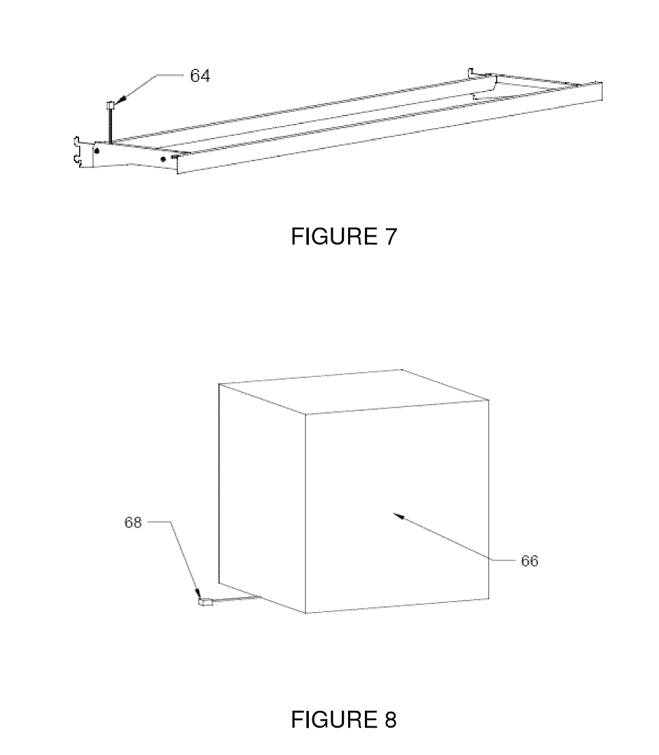

Referring to FIGS. 5 and 6, illumination may be provided by system 26 in several ways. For example, an LED strip 60 may be positioned so that it extends along the lower surface of the forward edge 62 of shelf 50 to direct light downwardly toward any items positioned below shelf 50. As seen in FIG. 7, shelf 50 may further include an auxiliary power outlet 64 interconnected to brackets 52 and 54 so that an illumination source, such as a graphic cube 66 as shown in FIG. 8, that has a corresponding plug 68 may be receive power by connecting to outlet 64. Alternatively, as additionally seen in FIG. 4, shelf 50 may be configured to include illuminated header 70 extending along forward edge 62, or shelf 50 may be replaced by an upstanding graphic panel display 72 that includes illumination to backlight the panel display 72.

In every embodiment, power may be disconnected from the illumination source by disconnecting the supporting brackets 52 and 54 from standards 44 and 46. As soon as shelf 50, for example is disconnected from standards 44 and 46, power will be disconnected, and when shelf 50 is reconnected to standards 44 and 46, such as in a new location, power is instantly restored without the need for any further action, such as plugging the illumination source into a new outlet located proximately to the new shelf location. As seen in FIG. 4, multiple shelves 50 may be attached to panel 32 and configured to provide a well-illuminated display that can easily be reconfigured with ease and without the need to plug, unplug, and re-plug the various illumination sources. Thus, system 26 is remarkably flexible and provides a modular illumination system that can be quickly and easily adapted to provide a wide variety of illumination arrangements that are aesthetically pleasing.

What is claimed is:

1. A modular display illumination system, comprising:
a power source; and
a panel having a first and a second side;
first and second electrically conductive standards supported by said patent and accessible from said first side of said panel that are operatively connected to said power source; and
at least one connector connected to said second side of said panel for mounting said panel on a vertical surface.

2. The system of claim 1, further comprising a shelf having first and second electrically conductive brackets spaced and configured for releasably attaching to said first and second standards, respectively.

3. The system of claim 2, wherein said shelf further comprises a light source mounted thereto and operatively connected to said first and second brackets.

4. The system of claim 1, wherein said at least one connector is configured for releasably attaching to a gondola display.

5. The system of claim 1, wherein said first standard is operatively connected to the positive terminal of said power source and said second standard is operatively connected to the negative terminal of said power source.

6. The system of claim 1, further comprising an auxiliary power outlet operatively connected to said first and second shelf brackets.

7. The system of claim 6, further comprising a light cube having an electrical connector adapted to releasably connect to and receive power from said auxiliary power outlet.

8. The system of claim 1, further comprising an cover having artwork affixed to said first side of said panel.

9. The system of claim 1, further comprising a header having electrically conductive first and second brackets spaced apart from each other and configured for releasably attaching to said first and second standards and to receive power from said standards, said header including a light source operatively connected to said bracket.

10. A method for attaching a modular illuminable display and shelving system, comprising the steps of:
attaching a panel having a first and a second side, first and second electrically conductive standards supported by said patent and accessible from said first side of said panel that are operatively connected to said power source to a vertical surface using at least one connector connected to said second side of said panel; and
operatively attaching a power source to said first and second electrically conductive standards.

11. The method of claim 10, further comprising the steps of:
attaching a shelf having first and second electrically conductive brackets that are spaced apart from each other to said first and second standards, respectively.

12. The method of claim 11, wherein said shelf further comprises a light source operatively connected to said power source via said first and second brackets and said first and second standards.

13. The method of claim 10, wherein said at least one connector is configured to releasably attach to a gondola display.

14. The method of claim 10, wherein said first standard is operatively connected to the positive terminal of said power source and said second standard is operatively connected to the negative terminal of said power source.

15. The method of claim 10, further comprising the steps of:
providing an auxiliary power outlet;
operatively connecting said auxiliary power outlet to said first and second bracket.

16. The method of claim 15, further comprising the steps of:
providing a cube source having an electrical connector adapted to releasably connect to and receive power from said auxiliary power outlet.

17. The method of claim 10, further comprising the step of affixing an artwork cover to said first side of said panel.

18. The method of claim 10, further comprising the steps of
attaching a header having first and second brackets spaced apart from each other to said first and second standards, respectively, wherein said header has a light source operatively connected to said first and second brackets.
